(19) United States
(12) Patent Application Publication
(10) Pub. No.: US 2025/0233418 A1
(43) Pub. Date: Jul. 17, 2025

(54) SERVER, BUILDING ENERGY MANAGEMENT SYSTEM, AND BUILDING ENERGY MANAGEMENT METHOD

(71) Applicant: Mitsubishi Electric Corporation, Tokyo (JP)

(72) Inventors: Tomohiro NARUI, Tokyo (JP); Toshihiro MEGA, Tokyo (JP); Fuyuki SATO, Tokyo (JP); Kazuyuki NAGAHIRO, Tokyo (JP); Shinichiro OTANI, Tokyo (JP); Hiroki KAWANO, Tokyo (JP)

(73) Assignee: Mitsubishi Electric Corporation, Tokyo (JP)

(21) Appl. No.: 19/098,296

(22) Filed: Apr. 2, 2025

Related U.S. Application Data
(63) Continuation of application No. PCT/JP2022/039137, filed on Oct. 20, 2022.

(51) Int. Cl. H02J 3/28

(52) U.S. Cl. CPC H02J 3/28; H02J 2310/12

(57) ABSTRACT

A server includes a processor which performs a computation process to determine, among a plurality of energy storage facilities, an energy storage facility to store power generated by a natural energy supply to. When the power generated by the natural energy supply is greater than power consumed by a building and surplus power is produced, the processor extracts one or more energy storage facilities, among the plurality of energy storage facilities, whose periods requiring continued energy storage depending on facility specifications are less than a duration during which the surplus power is greater than a predetermined amount. The processor calculates, for each of the one or more energy storage facilities, an amount of reduction of electricity cost if the energy storage facility stores the surplus power, to determine an energy storage facility to store the surplus power to, based on the amount of reduction.

### CROSS REFERENCE TO RELATED APPLICATIONS

The present application is a continuation of International application No. PCT/JP2022/039137, filed on Oct. 20, 2022, the entire contents of which are incorporated herein by reference.

### TECHNICAL FIELD

The present disclosure relates to a server, a building energy management system including the same, and a building energy management method.

### BACKGROUND ART

In recent years, with the broad recognition of the importance of renewable energy, a photovoltaics (PV) facility is introduced into more buildings. With the growing popularity of the PV facility, more power is generated by the PV facility. Due to the increase in power generated by the PV facility, there is also a building “Net Zero Energy Building (ZEB)” whose total balance of the primary energy achieves zero (or generally zero) over the course of a year.

### CITATION LIST

### Patent Literature

PTL 1: Japanese Patent Laying-Open No. 2007-295680

PTL 2: Japanese Patent Laying-Open No. 2017-79564

PTL 3: Japanese Patent Laying-Open No. 2019-88151

PTL 4: WO2013/168814

### SUMMARY OF INVENTION

### Technical Problem

Installing, besides the PV facility, an energy storage facility storing the energy in the form of electricity or heat in a building is considered, as disclosed in Japanese Patent Laying-Open No. 2007-295680 (PTL 1), for example. These energy storage facilities store energy during a time slot (such as nighttime) where the power demand and the electrxicity cost are low, and consume energy during a time slot (such as daytime) where the power demand and the electricity cost are high, thereby enabling the electricity cost reduction while achieving energy saving.

In a building such as a ZEB, the amount of power generated by the PV facility surpasses the power consumption of the building, which may produce surplus power. The surplus power can vary in time, depending on the weather change and the like. In addition, multiple energy storage facilities (such as a combination of a power storage facility and a thermal storage facility) may be installed in a building. In such a case, how to take advantage of the surplus power to strike a balance between the energy efficiency and the cost efficiency can be a problem.

The present disclosure is made to solve the above problem, and an object of the present disclosure is to strike a balance between the energy efficiency and the cost efficiency of a building.

### Solution to Problem

A server according to one aspect of the present disclosure manages energy in a building provided with: a natural energy supply which generates power that varies depending on meteorological conditions; and a plurality of energy storage facilities each storing energy in a form of electricity or heat. The server includes a processor which performs a computation process to determine, among the plurality of energy storage facilities, an energy storage facility to store the power, generated by the natural energy supply, to. when the power generated by the natural energy supply is greater than power consumed by the building and surplus power is produced, the processor extracts one or more energy storage facilities, among the plurality of energy storage facilities, whose periods requiring continued energy storage depending on facility specifications are less than a duration during which the surplus power is greater than a predetermined amount, and calculates, for each of the one or more energy storage facilities, an amount of reduction of electricity cost if the energy storage facility stores the surplus power, to determine an energy storage facility to store the surplus power to, based on the amount of reduction.

A building energy management method according to another aspect of the present disclosure manages energy in a building provided with: a natural energy supply which generates power that varies depending on meteorological conditions; and a plurality of energy storage facilities each storing energy in a form of electricity or heat. The building energy management method includes first, second, third, and fourth steps. The first step includes determining whether the power generated by the natural energy supply is greater than power consumed by the building and surplus power is produced. The second step includes extracting, when the surplus power is produced, one or more energy storage facilities, among the plurality of energy storage facilities, whose periods requiring continued energy storage are less than a duration during which the surplus power is greater than a predetermined amount. The third step includes calculating, for each of the one or more energy storage facilities, an amount of reduction of electricity cost if the energy storage facility stores the surplus power, to determine an energy storage facility to store the surplus power to, based on the amount of reduction.

### Advantageous Effects of Invention

According to the present disclosure, the energy efficiency and the cost efficiency of a building can be balanced.

### BRIEF DESCRIPTION OF DRAWINGS

FIG. 1 is a diagram illustrating one example of an overall configuration of a building energy management system according to an embodiment of the present disclosure.

FIG. 2 is a diagram showing a typical configuration of a server.

FIG. 3 is a schematic diagram for illustrating facility specifications data.

FIG. 4 is a schematic diagram for illustrating facility results data.

FIG. 5 is a schematic diagram for illustrating first power consumption data.

FIG. 6 is a schematic diagram for illustrating second power consumption data.

FIG. 7 is a schematic diagram for illustrating an electricity cost table.

FIG. 8 is a functional block diagram of a server according to the present embodiment.

FIG. 9 is a diagram for illustrating one example of a surplus power calculation approach.

FIG. 10 is a diagram for illustrating one example of an approach to extract candidates for an energy storage facility to store surplus power.

FIG. 11 is a diagram for illustrating one example of a cost calculation approach.

FIG. 12 is a flowchart illustrating a procedure for a computation process related to surplus power according to an embodiment.

FIG. 13 is a diagram for illustrating an approach to extract candidates for an energy storage facility to store surplus power according to a variation of the embodiment of the present disclosure.

FIG. 14 is a flowchart illustrating a procedure for a computation process related to surplus power according to the variation.

### DESCRIPTION OF EMBODIMENTS

Hereinafter, an embodiment will be described, with reference to the accompanying drawings. Note that like reference signs are used to refer to like or corresponding parts in the drawings, and the description thereof will not be repeated.

### Embodiment

### <System Configuration>

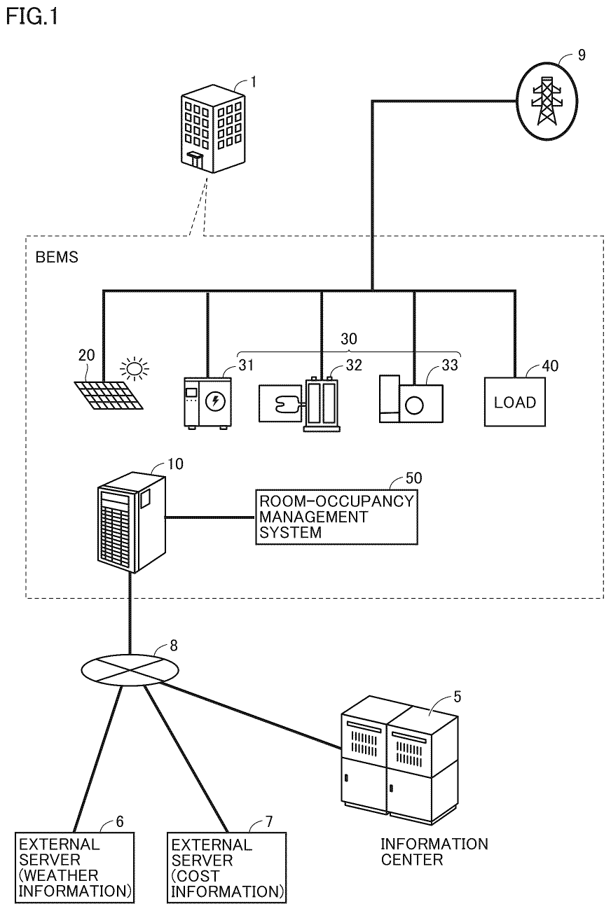

FIG. 1 is a diagram illustrating one example of an overall configuration of a building energy management system (BEMS) according to the present embodiment. In the present embodiment, a BEMS 1 manages the demand and supply of the energy (power and/or heat) used in office buildings. However, the facility to which the BEMS 1 is applicable is not limited to office buildings, and may be a commercial facility (such as a shopping mall), a sporting facility (such as a stadium), a cultural institution (such as a theater), etc., or a complex thereof.

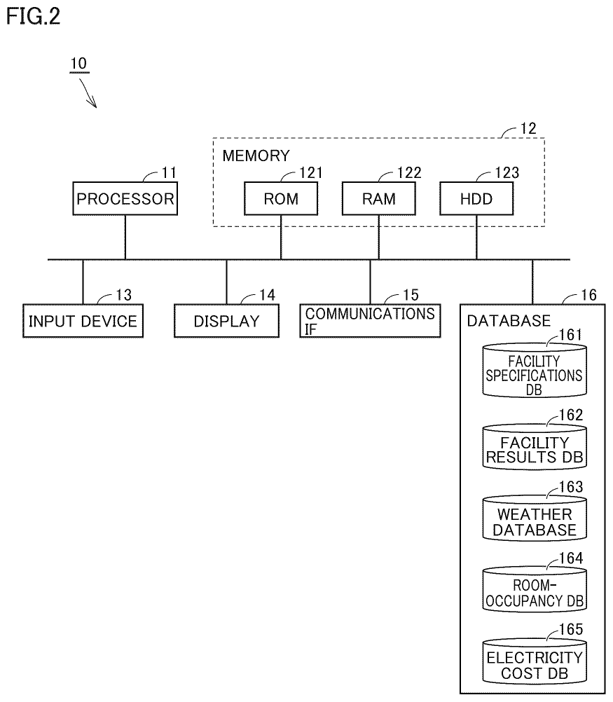

The BEMS 1 includes a server 10. The server 10 is a computer which manages respective facilities in the BEMS 1. A hardware configuration of the server 10 will be described with reference to FIG. 2. The server 10 is communicatively connected to a central server 5 and external servers 6 and 7 via a network 8 such as the Internet.

The central server 5 is installed at an information center run by an entity providing integrated management of many buildings. The central server 5 provides the server 10 with various information required to manage the respective facilities in the BEMS 1. The central server 5 can remotely control the respective facilities within the BEMS 1.

The external server 6 is operated by a meteorological agency, a private weather entity, etc., and provides the server 10 with weather forecast and weather information (such as weather, an outdoor air temperature, solar radiation, wind velocity, wind direction, rainfall, and a chance of rain). The external server 6 may provide the server 10 with weather hazard forecast (warnings or advisories about typhoons, heavy rain, floods, heavy snow, high winds, heat waves, cold snap, lightning, etc.).

The external server 7 is operated by, for example, a power company (which may be a power producer or an electricity transmission and distribution provider) and provides the server 10 with information on electricity cost.

In addition to the server 10, the BEMS 1 further includes one or more natural energy supplies (or variable renewable energy (VRE)) 20, multiple energy storage facilities 30, a load 40, and a room-occupancy management system 50. The natural energy supplies 20, the energy storage facilities 30, and the load 40 are connected to a power grid 9, for example.

The one or more natural energy supplies 20 are power generating facilities whose power generation can vary, depending on the meteorological conditions. In the present embodiment, the natural energy supply 20 is a photovoltaics facility (a PV facility). However, the natural energy supply 20 may be a wind power generating facility or a combination of a PV facility and a wind power generating facility.

The energy storage facilities 30 each store energy in the form of electricity or heat. In the present embodiment, the multiple energy storage facilities 30 include a power storage facility 31, a thermal storage facility 32, and a hot-water supply facility 33. The multiple energy storage facilities 30 may include only one or two types of such facilities. The multiple energy storage facilities 30 may include a Power to Gas facility (not shown) that uses power to produce a gaseous fuel (such as hydrogen, methane).

The power storage facility 31 is configured to store the power generated by the natural energy supply 20. The power storage facility 31 is, typically, a secondary battery (a lithium-ion battery, a nickel-hydrogen battery, etc.) or an electric double layer capacitor. The power that can be stored or supplied by the power storage facility 31 depends on a charge and discharge power, a charging time, and a charging efficiency. The power stored (stocked) in the power storage facility 31 may decrease over time.

The thermal storage facility 32 is configured to store heat generated with air conditioning (cooling or heating). The thermal storage facility 32, for example, includes a thermal storage vessel, and stores a liquid medium (typically, hot water) within the thermal storage vessel in a warmed state. The thermal storage facility 32 may be a waste heat recovery system or an ice storage system. The thermal storage facility 32 supplies the load 40 (in particular, air conditioning equipment) in the building with the heat stored in the form of hot water or ice. The temperature of the hot water or ice stored in the thermal storage facility 32 may change over time.

The hot-water supply facility 33 includes a heat exchanger for heating water. The hot-water supply facility 33 can be various types of water heaters such as an electrical hot water heater, a heat pump water heater, or a solar thermal water heater. The hot-water supply facility 33 supplies the hot water to the load 40 in the building. The temperature of the hot water stored in the hot-water supply facility 33 may change over time too.

Note that the stored energy for the power storage facility 31 is stored power, which is represented by a state of charge (SOC), for example. For the thermal storage facility 32 or the hot-water supply facility 33, the stored energy is stored heat, which is represented by the temperature of hot water or water, for example.

The load 40 is equipment that consumes energy (mainly, power). The load 40 includes, for example, air conditioning equipment, a lift (such as an elevator and escalator), lightning equipment, or various office automation (OA) equipment that are installed in a building.

The room-occupancy management system 50 is configured to manage data regarding people coming in and out of respective rooms in the building, using an integrated circuit (IC) card, a monitoring camera or technologies such as biometrics.

In the following, a computation process performed by the server 10 within the BEMS 1 will be described. The central server 5 installed in an information center (not shown) can have the same configuration as the server 10. Thus, the computation process below may be performed by the central server 5, instead of the server 10.

### <Server Configuration>

FIG. 2 is a diagram showing a typical configuration of the server 10. The server 10 includes a processor 11, a memory 12, an input device 13, a display 14, a communications interface 15, and a database 16.

The processor 11 is, for example, a central processing unit (CPU), and configured to perform a predetermined computation process in accordance with a program. The memory 12 includes a read only memory (ROM) 121, a random access memory (RAM) 122, and a hard disk drive (HDD) 123, and stores programs performed by the processor 11 and various data (such as maps, relational expressions, parameters) which are used in the programs. The input device 13 is, for example, a keyboard, a mouse, etc., and receives user operations. The display 14 provides various information to a user. The communications interface 15 is configured to communicate with external components (such as the central server 5 and the external servers 6 and 7).

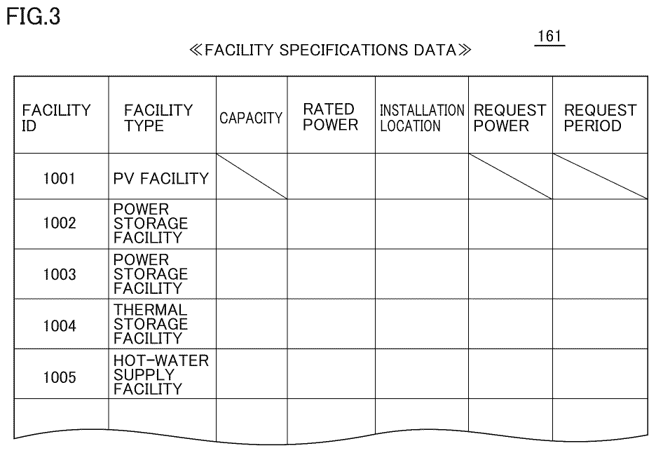

The database 16, in this example, includes a facility specifications database 161 storing facility specifications data, a facility results database 162 storing facility results data, a weather database 163 storing first power consumption data, a room-occupancy database 164 storing second power consumption data, and an electricity cost database 165 storing an electricity cost table. These data and tables are now described, with reference to FIGS. 3 to 7.

### <Database>

FIG. 3 is a schematic diagram for illustrating the facility specifications data. In the facility specifications data, specifications of the respective facilities are recorded to manage the natural energy supply 20 and the energy storage facility 30 within the BEMS 1. In this example, an identification number (a facility ID) is attached to each facility such as the natural energy supply 20 and the energy storage facility 30. For each facility ID, the facility specifications data includes a facility type, a capacity (the maximum energy that can be stored in that facility), and the rated power (the maximum energy that can be input/output per unit time to that facility). The facility specifications data may include the manufacturer (not shown), the model (not shown), the installation location, etc.

In the present embodiment, the facility specifications data for the energy storage facility 30 further includes a request power and a request period. In general, the power storage facility 31 is able to store power having any magnitude within the capacity and the rated power, right away. The thermal storage facility 32 and the hot-water supply facility 33, in contrast, convert the electrical energy into thermal energy. More specifically, hot water within the thermal storage vessel is produced (re-heated), ice is produced in the ice storage system, supplying hot water is produced (re-heated), etc. Such energy conversion requires uninterrupted supply, over a period of time, of power greater than a predetermined amount to the thermal storage facility 32 or the hot-water supply facility 33. Thus, minimum requisite power and time period that are required for efficient energy conversion are defined as a request power and a request period, respectively.

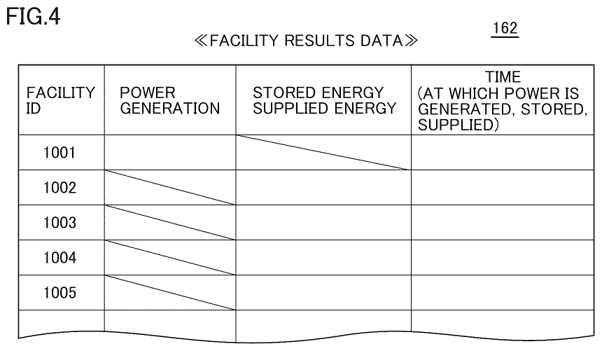

FIG. 4 is a schematic diagram for illustrating facility results data. In the facility results data, previous use of the facility (results of monitoring by the server 10 in the past) is recorded. The facility results data for the natural energy supply 20 includes a time and the actual value of power generated at that time, as the data associated with the facility ID. The facility results data for the energy storage facility 30 includes a time and the actual value of energy stored at that time or the actual value of energy supplied (the amount of supply of stored energy) at that time, as the data associated with the facility ID. Note that the time includes a time at which the power is generated, a time at which the energy is stored, and a time at which the energy is supplied.

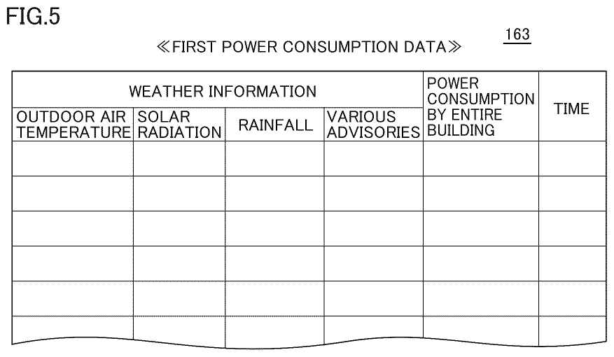

FIG. 5 is a schematic diagram for illustrating the first power consumption data. In the first power consumption data, power consumption by the BEMS 1 (the entire building) is recorded in association with the weather information. In this example, the first power consumption data includes, on a per-time of day basis, the weather information (an outdoor air temperature, solar radiation, rainfall, various triggered advisories, etc.) at that time, and the actual value of power consumption by the entire building at that time by the load 40 in the building. Note that the server 10 obtains the weather information from the external server 6.

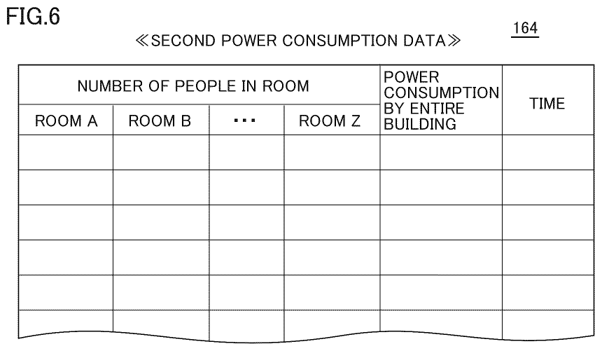

FIG. 6 is a schematic diagram for illustrating the second power consumption data. In the second power consumption data, the power consumption by the BEMS 1 (the entire building) is recorded in association with room-occupancy information. As mentioned earlier, in the BEMS 1, the number of people present in each room is obtained by the room-occupancy management system 50. In this example, the second power consumption data includes a time, the number of people present in each room at that time, and the actual value of power consumption by the entire building at that time by the load 40 in the building.

Due to the heat generated by people, the more the people are present in a room, the higher the temperature of the room increases. Moreover, there is a tendency that the more the people are present in a room, the more the power is consumed by the lightning equipment and the more the power is consumed by the OA equipment, etc. The second power consumption data may be data that is obtained through multivariate analysis, machine learning, etc. of the correlation between the number of people present in the room and the power consumption by each facility.

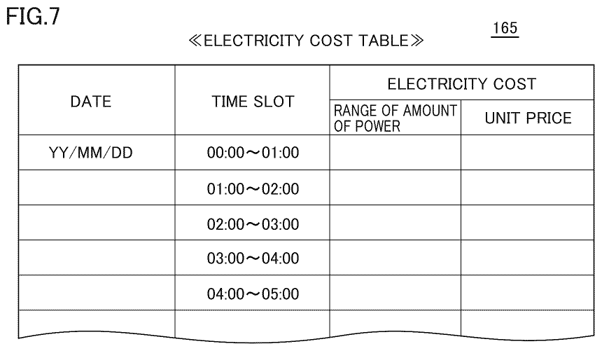

FIG. 7 is a schematic diagram for illustrating an electricity cost table. The electricity cost table, for example, includes data, for each time slot, regarding the unit price (price per 1 kWh) of the electricity cost by range of the amount of power generated or the power consumption. Note that the server 10 obtains the electricity cost table from the external server 7.

### <Functional Block>

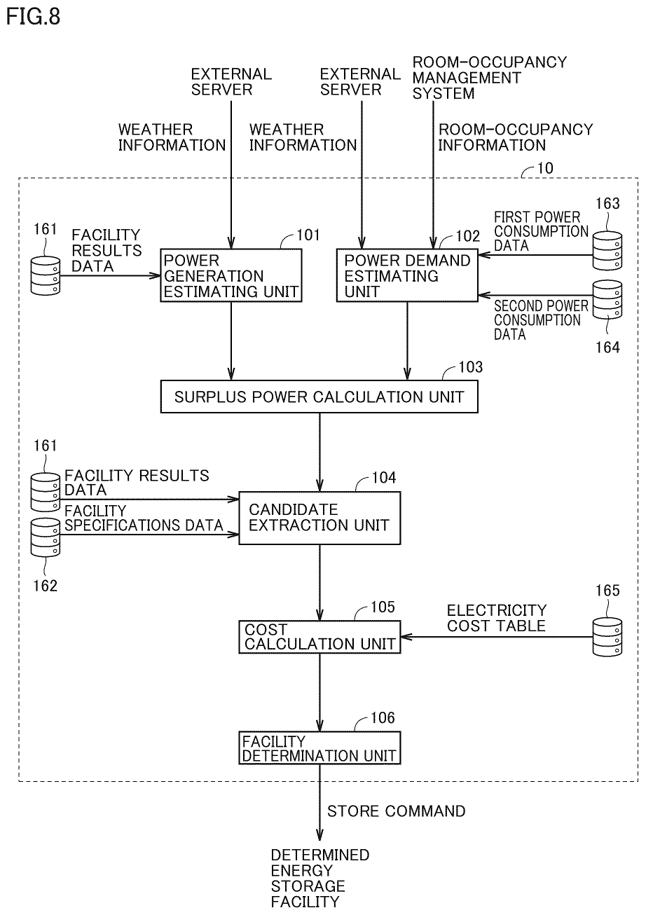

FIG. 8 is a functional block diagram of the server 10 according to the present embodiment. The server 10 includes a power generation estimating unit 101, a power demand estimating unit 102, a surplus power calculation unit 103, a candidate extraction unit 104, a cost calculation unit 105, and a facility determination unit 106.

The power generation estimating unit 101 estimates power generation by the natural energy supply 20 (a PV facility in the present embodiment). If the natural energy supply 20 includes multiple facilities (e.g., the PV facility and the wind power generating facility), the power generation estimating unit 101 estimates power generation by each facility. The power generation is estimated for each predetermined time frame (e.g., 30 minutes) over a predetermined time period (which may be 24 hours, three days, or one week) in the future from the current time. The power generation estimating unit 101 can estimate the power generation for each time frame, based on the weather forecast (such as the weather, an outdoor air temperature, solar radiation, the wind velocity, the wind direction, and rainfall, chance of rain) obtained from the external server 6, and the actual value (a history) of the power generation included in the facility results data. The power generation estimating unit 101 outputs a result of estimation of power generation to the surplus power calculation unit 103.

The power demand estimating unit 102 estimates a power demand (which may be referred to as power consumption) in the BEMS 1 for each time frame over the predetermined time period noted above. More specifically, the power demand estimating unit 102 can estimate a power demand for each time frame, based on the weather forecast obtained from the external server 6, the room-occupancy management information obtained from the room-occupancy management system 50, and the actual values of the power consumption included in the first power consumption data and the second power consumption data.

The power demand estimating unit 102 may estimate the power demand based only on the first power consumption data. However, by the power demand estimating unit 102 using both of the first power consumption data and the second power consumption data, stated differently, using the second power consumption data to correct the first power consumption data, the accuracy in estimation of the power demand improves. The power demand estimating unit 102 outputs a result of the estimation of the power demand to the surplus power calculation unit 103.

The surplus power calculation unit 103 calculates a surplus power in the BEMS 1, based on the power generation estimated by the power generation estimating unit 101 and the power demand estimated by the power demand estimating unit 102.

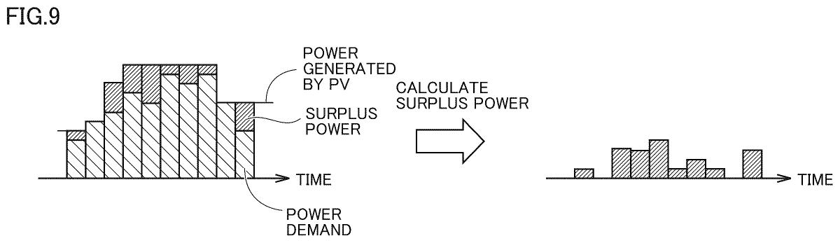

FIG. 9 is a diagram for illustrating one example of a surplus power calculation approach. The surplus power calculation unit 103 calculates the difference between the surplus power and the power demand as a surplus power for each time frame over the predetermined time period noted above.

Returning to FIG. 8, the candidate extraction unit 104 extracts one or more facilities that can store energy corresponding to the surplus power (i.e., a facility that can store the surplus power, or a facility that can store the heat generated by the surplus power) from the multiple energy storage facilities 30.

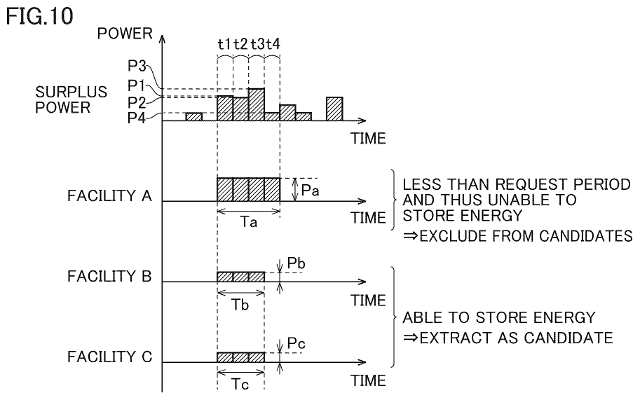

FIG. 10 is a diagram for illustrating one example of the approach to extract candidates for the energy storage facility 30 to store the surplus power. The candidate extraction unit 104 extracts candidates, based on two conditions.

A first condition is about the storage space of the energy storage facility 30 (remaining energy that can be stored into this facility). The storage space of the energy storage facility 30 can be calculated from the difference between the capacity of this facility (the maximum energy that can be stored in this facility) and the energy already stored in this facility. The candidate extraction unit 104 can obtain the capacity from the facility specifications data and obtain the already-stored energy from the facility results data. If the energy storage facility 30 has a storage space that can store energy corresponding to the surplus power, the candidate extraction unit 104 determines that this facility meets the first condition.

In the example shown in FIG. 10, the energy storage facilities 30 include three facilities A, B, and C. Here, assume that all of the three facilities A, B, and C meet the first condition.

A second condition is about a request power and a request period which are requested for the effective energy conversion described with respect to FIG. 4. The request power from the facility A will be described as Pa, and the request period from the facility A will be described as Ta. The same is true for the facilities B and C. In this example, the request period Ta, in which the surplus power is required to be greater than the request power Pa, corresponds to four time frames (e.g., 2 hours). Request periods Tb and Tc correspond to three time frames (e.g., 1.5 hours). The surplus powers in four time frames t1, t2, t3, and t4 will be described as P1, P2, P3, P4, respectively.

For the facility A, the surplus power P1 to P3 are greater than the request power Pa in the three time frames t1 to t3, among the four time frames t1 to t4 corresponding to the request period Ta. However, the surplus power P4 in the time frame t4 is less than the request power Pa. In this case, in the time frame t4, energy required to produce hot water in the thermal storage vessel or energy required to produce ice in the ice storage system is not supplied to the facility A. Consequently, the effective energy conversion may not be fulfilled. Accordingly, the facility A is not to be extracted as a candidate.

For the facility B, in contrast, the surplus power P1 to P3 are greater than the request power Pb in all three time frames t1 to t3 corresponding to the request period Tb. Similarly, for the facility C, the surplus power P1 to P3 are greater than the request power Pc in all three time frames t1 to t3. In this case, energy required to produce hot water or ice is supplied to the facilities B and C. Consequently, the effective energy conversion can be fulfilled. Accordingly, the facilities B and Care to be extracted as candidates.

Referring, again, to FIG. 8, the cost calculation unit 105 calculates a cost to be reduced if the surplus power (energy corresponding to the surplus power) is stored in the one or more candidates (in this example, the facilities B and C) extracted by the candidate extraction unit 104.

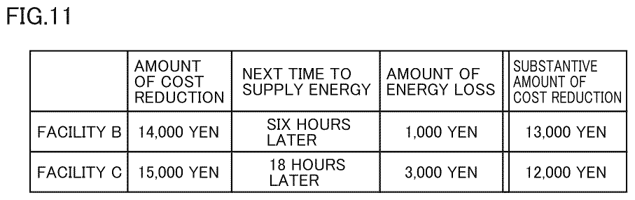

FIG. 11 is a diagram for illustrating one example of the cost calculation approach. Initially, the cost calculation unit 105 calculates an amount of cost reduction for each of the facilities B and C. The amount of cost reduction is an estimated amount of cost to be reduced if the energy is stored in the energy storage facility 30. For example, the cost calculation unit 105 can calculate the amount of cost reduction by the facility by using a unit price included in the electricity cost table to convert the energy stored in the facility (the amount of power, or an amount of power converted from an amount of heat) into money. In this example, the amount of cost reduction by the facility B is 14,000 yen, and the amount of cost reduction by the facility C is 15,000 yen.

The cost calculation unit 105 calculates the amount of energy loss for each of the facilities B and C. The amount of energy loss is obtained by converting, into money, the energy loss that is produced until the energy stored in the energy storage facility 30 is supplied to the load 40. As mentioned earlier, the facility results data includes the energy loss that is produced per unit time (each time frame) at each energy storage facility 30. Since the facility results data includes the time at which the energy is supplied from the energy storage facility 30, the time at which each energy storage facility 30 next supplies energy to the load 40 is predictable. Accordingly, the cost calculation unit 105 calculates the sum of energy loss produced until the time of supply of the energy, based on the energy loss per unit time, and uses the unit price included in the electricity cost table to convert the calculated sum of energy loss into money, thereby calculating the amount of energy loss. In this example, the amount of energy loss by the facility B is 1,000 yen, and the amount of energy loss by the facility C is 3,000 yen.

The cost calculation unit 105 subtracts the amount of energy loss from the amount of cost reduction for each of the facilities B and C to calculate a substantive amount of cost reduction. In this example, the substantive amount of cost reduction by the facility B is 14,000 yen minus 1,000 yen equals 13,000 yen, and the substantive amount of cost reduction by the facility C is 15,000 yen minus 3,000 yen equals 12,000 yen. In other words, comparing the facility B and the facility C, the facility C has a greater amount of cost reduction, without taking into account the energy loss. However, the facility B has a greater substantive amount of cost reduction, taking into account the energy loss.

Returning to FIG. 8, based on a result of the calculation by the cost calculation unit 105, the facility determination unit 106 determines a facility to store the surplus power to, among the candidates (the facilities B and C in the example described with respect to FIG. 10) extracted by the candidate extraction unit 104. More specifically, as the facility to store the surplus power, the facility determination unit 106 determines a facility that has the greatest substantive amount of cost reduction calculated by the cost calculation unit 105 (the facility B in the example described with respect to FIG. 11). The facility determination unit 106 outputs an energy store command to the determined facility.

### <Process Flow>

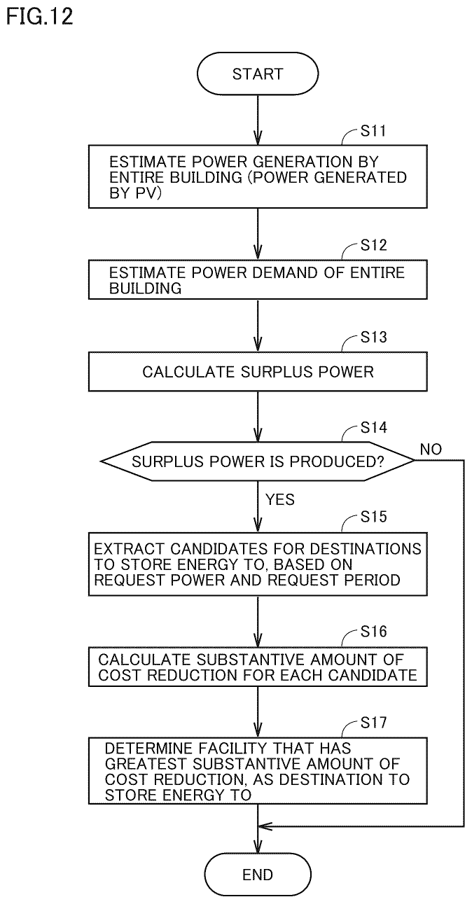

FIG. 12 is a flowchart illustrating a procedure for the computation process related to the surplus power according to the embodiment. The process illustrated in this flowchart is performed once a predetermined condition is met (e.g., for each predetermined cycle). Each process step is implemented by software processing by the processor 11 within the server 10. However, each process step may be implemented by hardware (an electric circuit) disposed within the server 10. Hereinafter, each process step is abbreviated as S.

In S11, the server 10 estimates power generation by the entire building by the natural energy supply 20 for each time frame over a predetermined time period in the future. In the present embodiment, power generation by the PV facility is estimated. The server 10 can estimate the power generation for each time frame over the time period, based on the weather information (e.g., solar radiation) and the actual values of power generated by respective PV facilities which are included in the facility results data.

In S12, the server 10 estimates a power demand of the entire building for each time frame over the predetermined time period. For example, the server 10 can estimate the power demand of the entire building, based on the first power consumption data based on the weather information, and the actual value of the power consumption by the load 40 included in the facility results data. As mentioned earlier, the server 10 can improve the accuracy in estimation of the power demand by using the first power consumption data that is based on the room-occupancy information.

In S13, the server 10 calculates surplus power for each time frame over the predetermined time period, based on the power generation calculated in S11 and the power demand calculated in S12. The surplus power is calculated by subtracting the power demand from the power generation, as described with respect to FIG. 9.

In S14, the server 10 determines whether the surplus power is produced. If the power demand is greater than the power generation over the predetermined time period and no surplus power is produced (NO in S14), the server 10 ends the series of process steps, without performing the subsequent process steps. If surplus power is produced at least in a part of the predetermined time period (YES in S14), the server 10 passes the process to S15.

In S15, the server 10 extracts one or more facilities that can store the surplus power (energy corresponding to the surplus power), as candidates, from multiple energy storage facilities 30, based on a request power and a request period determined for each energy storage facility 30. This extraction approach has been described in detail with respect to FIG. 10, the descriptions thereof will not, thus, be repeated here.

In S16, for each candidate extracted in S15, the server 10 calculates a substantive amount of cost reduction, taking into account the energy loss that is produced since the energy is stored until the energy is supplied. This calculation approach has been described in detail with respect to FIG. 11, the descriptions thereof will not, thus, be repeated here.

In S17, the server 10 determines a facility that has the greatest substantive amount of cost reduction, among the one or more candidates, as a destination to store the surplus power to. Note that if there are a larger number of candidates, for example, the server 10 may determine, in addition to the facility having the greatest substantive amount of cost reduction, other facility having a great substantive amount of cost reduction (such as a facility having the second greatest substantive amount of cost reduction), as another destination to store the surplus power to. For example, when the surplus power is great, the server 10 can determine two facilities having great substantive amounts of cost reduction, as destinations to store the surplus power to.

As described above, in the present embodiment, one or more energy storage facilities 30 satisfying the conditions for the request power and the request period are extracted from multiple energy storage facilities 30. This allows the surplus power to be efficiently stored in the extracted energy storage facility 30. More specifically, since the effective energy conversion is performed at the extracted energy storage facility 30, the energy loss is small. Accordingly, increased energy can be stored, while reducing the amount of energy loss. Thus, according to the present embodiment, the energy efficiency and the cost efficiency of the building can be balanced.

### Variation

In Variation, a configuration is now described in which an energy-saving control of a building is performed to more efficiently store surplus power.

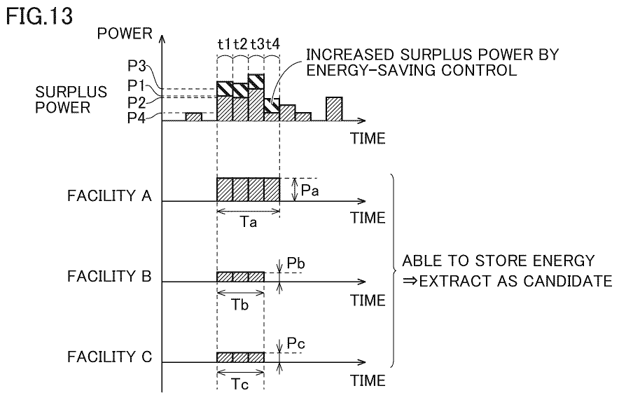

FIG. 13 is a diagram for illustrating an approach to extract candidates for the energy storage facility 30 to store the surplus power according to Variation. The server 10 can control an air conditioning equipment, lightning equipment, or a lift to perform the energy-saving control of a building (the load 40 in the BEMS 1), for example. As the energy-saving control reduces power consumption by the entire building, as much the surplus power increases.

In FIG. 10, the facility A is not extracted as a candidate. This is because the surplus power P4 in the time frame t4 does not satisfy the request power Pa and the effective energy conversion is not to be fulfilled. As shown in FIG. 13, however, as the energy-saving control increases the surplus power, the surplus power P4 in the time frame t4 can be exceed the request power Pa. In that case, the effective energy conversion can be fulfilled even at the facility A. The facility A is, therefore, extracted as a candidate too. As such, candidates for one or more energy storage facilities 30 satisfying the conditions about the request power and the request period can be increased by increasing the surplus power through the energy-saving control.

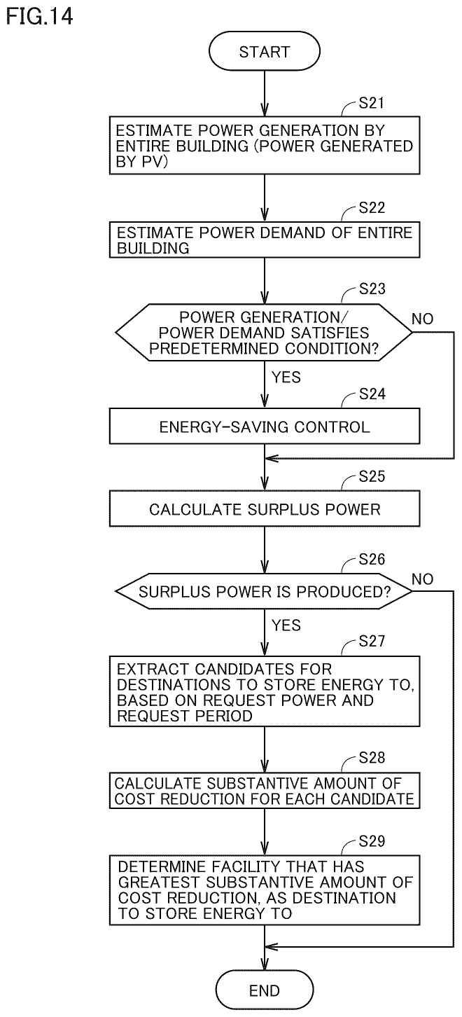

FIG. 14 is a flowchart illustrating a procedure for the computation process for the surplus power according to Variation. Process steps of S21 and S22 are equivalent to the process steps of S11 and S12 according to the embodiment (see FIG. 12).

In S23, the server 10 determines whether the power generation by the natural energy supply 20 and/or the power demand of the entire building satisfies a predetermined condition. For example, the server 10 may determine that the condition is satisfied if the power generation does not satisfy a first reference quantity, determine that the condition is satisfied if the power demand is greater than a second reference quantity, or determine the condition is satisfied if the power generation does not satisfy the first reference quantity and the power demand is greater than the second reference quantity. If the condition is satisfied (YES in S23), the server 10 passes the process to S24. Note that, if the condition is not satisfied (NO in S23), the server 10 skips the process step of S24 and passes the process to S25.

In S24, the server 10 performs the energy-saving control of the building (the load 40 in the BEMS 1). The energy-saving control may be reducing the volume of air or changing the set temperature of an air conditioning equipment, or reducing the light emitting area or an amount of light emitted by lightning equipment. The energy-saving control may be, for example, an intermittent operation of a lift (such as an elevator and escalator) or a power-saving control of OA equipment. Since the process steps at and after S25 are the same as those at and after S13 according to the embodiment, the description thereof will not be repeated.

Moreover, while not shown, when the server 10 receives a weather hazard forecast (warnings or advisories about typhoons, heavy rain, floods, heavy snow, high winds, heat waves, cold snap, lightning, etc.) from the external server 6, the server 10 may increase the amount of energy stored in the energy storage facility 30 greater than normal times (when receives no weather hazard forecast) as preparedness for a weather hazard. In other words, the server 10, if it receives no weather hazard forecast, causes energy greater than a first specified amount to be stored into each energy storage facility 30. If the server 10 receives a weather hazard forecast, in contrast, the server 10 causes energy exceeding a second specified amount greater than the first specified amount to be stored into each energy storage facility 30.

As described above, similarly to the embodiment, one or more energy storage facilities 30 satisfying the conditions about the request power and the request period are extracted from multiple energy storage facilities 30. This allows the energy efficiency and the cost efficiency of the building to balanced. Furthermore, in Variation, the surplus power is further increased through the energy-saving control of the building. This can increase candidates for destinations to store the surplus power to. In other words, more effective energy conversion is performed, increasing the possibility of extracting the energy storage facility 30 that has a fewer energy loss. Thus, the energy efficiency and the cost efficiency of the building can be balanced to a higher degree.

The presently disclosed embodiments should be considered in all aspects as illustrative and not restrictive. The scope of the present disclosure is indicated by the appended claims, rather than by the embodiments above, and all changes that come within the scope of the claims and the meaning and range of equivalency of the claims are intended to be embraced within their scope.

### INDUSTRIAL APPLICABILITY

1 BEMS; 5 central server; 6, 7 external server; 8 network; 9 power grid; 10 server; 11 processor; 12 memory; 13 input device; 14 display; 15 communications interface; 16 database; 161 facility specifications database; 162 facility results database; 163 weather database; 164 room-occupancy database; 165 electricity cost database; 20 natural energy supply; 30 energy storage facility; 31 power storage facility; 32 thermal storage facility; 33 hot-water supply facility; 40 load; 50 room-occupancy management system; 101 power generation estimating unit; 102 power demand estimating unit; 103 surplus power calculation unit; 104 candidate extraction unit; 105 cost calculation unit; and 106 facility determination unit.

1. A server for managing energy in a building provided with: a natural energy supply which generates power that varies depending on meteorological conditions; and a plurality of energy storage facilities each storing energy in a form of electricity or heat, the server comprising
a processor which performs a computation process to determine, among the plurality of energy storage facilities, an energy storage facility to store the power, generated by the natural energy supply, to, wherein
when the power generated by the natural energy supply is greater than power consumed by the building and surplus power is produced, the processor
extracts one or more energy storage facilities, among the plurality of energy storage facilities, whose periods requiring continued energy storage depending on facility specifications are less than a duration during which the surplus power is greater than a predetermined amount, and
calculates, for each of the one or more energy storage facilities, an amount of reduction of electricity cost if the energy storage facility stores the surplus power, to determine an energy storage facility to store the surplus power to, based on the amount of reduction.

2. The server according to claim 1, wherein
the processor performs an energy-saving control that reduces the power consumed by the building to extend the duration during which the surplus power is greater than the predetermined amount, to increase a total number of energy storage facilities to be extracted as the one or more energy storage facilities.

3. The server according to claim 1, wherein
the processor calculates, for each of the one or more energy storage facilities, the amount of reduction based on an electricity cost converted from the surplus power stored in the energy storage facility and an electricity cost converted from an energy loss that is produced until the surplus power stored in the energy storage facility is consumed.

4. The server according to claim 1, wherein
the building is further provided with a room-occupancy management system which manages room-occupancy information on a person in a plurality of rooms in the building, and
the processor uses the room-occupancy information to estimate the power consumed by the building.

5. The server according to claim 1, wherein
when the processor receives no forecast of a weather hazard, the processor causes the power generated by the natural energy supply to be stored into the plurality of energy storage facilities so that energy greater than a first specified amount is stored into each of the plurality of energy storage facilities, and
when the processor receives the forecast, the processor causes the power generated by the natural energy supply to be stored into the plurality of energy storage facilities so that energy greater than a second specified amount greater than the first specified amount is stored into each of the plurality of energy storage facilities, as preparedness for the weather hazard.

6. A building energy management system, comprising:
the server according to claim 1;
the natural energy supply; and
the plurality of energy storage facilities.

7. A building energy management method for managing energy in a building provided with: a natural energy supply which generates power that varies depending on meteorological conditions; and a plurality of energy storage facilities each storing energy in a form of electricity or heat, the building energy management method comprising:
determining whether the power generated by the natural energy supply is greater than power consumed by the building and surplus power is produced;
extracting, when the surplus power is produced, one or more energy storage facilities, among the plurality of energy storage facilities, whose periods requiring continued energy storage are less than a duration during which the surplus power is greater than a predetermined amount; and
calculating, for each of the one or more energy storage facilities, an amount of reduction of electricity cost if the energy storage facility stores the surplus power, to determine an energy storage facility to store the surplus power to, based on the amount of reduction.
